(19) United States
(12) Patent Application Publication
(10) Pub. No.: US 2016/0158790 A1
(43) Pub. Date: Jun. 9, 2016

(54) DIP COATING HOLDER TOOL AND METHOD FOR DIP-COATING A SUBSTRATE

(71) Applicant: KABUSHIKI KAISHA TOSHIBA, Tokyo (JP)

(72) Inventors: Akira WATANABE, Kawasaki Kanagawa (JP); Tsuyoshi ONITSUKA, Hino Tokyo (JP)

(21) Appl. No.: 14/739,591

(22) Filed: Jun. 15, 2015

(30) Foreign Application Priority Data
Dec. 9, 2014 (JP) 2014-249063

(51) Int. Cl. B05C 3/02; B05D 1/18

(52) U.S. Cl. CPC B05C 3/02; B05D 1/18

(57) ABSTRACT

A tool for dip-coating a disc-shaped substrate having a through hole therein includes a support member having a portion made of a porous material, that is to be inserted into the through hole and support the disc-shaped substrate during the dip-coating. Further, a method for dip-coating a disc-shaped substrate having a through hole therein, includes supporting the substrate on a portion of a tool, the portion being made of a porous material, submerging the substrate and the tool into a dip coating liquid, and taking the substrate and the tool out of the dip coating liquid.

### CROSS-REFERENCE TO RELATED APPLICATION

This application is based upon and claims the benefit of priority from Japanese Patent Application No. 2014-249063, filed Dec. 9, 2014, the entire contents of which are incorporated herein by reference.

### FIELD

Embodiments described herein relate to a dip coating holder tool and a method for dip-coating a substrate using the tool.

### BACKGROUND

In various lithography techniques such as electronic beam lithography, photo lithography, nano imprint, and self-organization of polymers or fine particles, it is necessary to apply a resist to a substrate. Method of applying the resist include a spin coating method, an inkjet method, a spray coating method, and a dip coating method. Specifically, according to the dip coating method, a substrate is immersed in a resist solution, and then the substrate is pulled up. The dip coating method is beneficial for mass production, because the amount of resist used and process time can be reduced. For this reason, the dip coating method is favorably used in a step of applying a lubricant to a hard disk drive (HDD) medium or the like.

The dip coating method employs a technique of forming a resist layer using a meniscus formed on an interface between the substrate and the resist solution. When the dip coating method is employed to form a layer on a substrate such as an HDD medium having a hole at a center portion of the substrate, the film thickness variations may be generated for three reasons: (1) a liquid pool generated between a holder jig and the substrate, (2) shaking of a liquid surface caused by droplets dropped from the holder jig, and (3) shaking of a liquid surface caused by breaking of a meniscus at the hole of the substrate.

With respect to (1), the liquid pool of a solvent adhered to the holder jig (hanger arm) may be removed by forming a V-shaped groove on an upper edge of the holder jig so as to decrease a contact area of the holder jig with the substrate. With respect to (2), the droplet falling from the holder jig (hanger arm) may be suppressed by lowering an end of the hanger arm downward. However, the above-described techniques may not prevent the shaking of a liquid surface caused by breaking of a meniscus (i.e., the reason (3)).

In order to form a uniform coating film using the dip coating method, it is necessary to contiguously form the coating film without breaking the meniscus from an upper end to a lower end of the substrate. However, when the substrate has a hole (such as an HDD medium), the meniscus cannot be formed in the hole portion of the substrate. As a result, the meniscus may be broken at the hole portion of the substrate. Breaking of a meniscus means that a film of a solution formed at the hole portion is cracked. Due to breaking of the meniscus, a liquid surface of the solution vibrates and non-uniform film thickness distribution may be generated. To prevent the breaking of the meniscus at the hole portion, the substrate may be pulled up at a slow speed. However, the lowering of a pull-up speed may not be practical because it reduces productivity.

### DESCRIPTION OF THE DRAWINGS

FIG. 1 illustrates a dip coating tool according to an embodiment.

FIG. 2 is a schematic view of a holding member holding a plurality of substrates.

FIG. 3 is a front view of the holding member of a dip coating tool according to a third embodiment.

FIG. 4 is a side view of the holding member shown in FIG. 3.

FIG. 5 is a schematic view of the dip coating tool according to the third embodiment.

FIG. 6 is a front view of a holding member of a dip coating tool according to a fourth embodiment.

FIG. 7 is a side view of the holding member shown in FIG. 6.

FIG. 8 is a perspective view of a magnetic recording and reproducing apparatus.

### DETAILED DESCRIPTION

One or more embodiment provide a dip coating holder tool and a method for dip-coating a substrate with a coating film having a more uniform film thickness distribution.

In general, according to one embodiment, a tool for dip-coating a disc-shaped substrate having a through hole therein includes a support member having a portion made of a porous material, that is to be inserted into the through hole and support the disc-shaped substrate during the dip-coating

The dip coating holder jig (tool) according to an embodiment is a holder jig used when dip coating is carried out on a substrate having a first through hole at a central region thereof. The dip coating holder jig includes a holding member (support member) having a porous material at least at a portion thereof, and insertable into the first through hole.

A dip coating system according to an embodiment includes the dip coating holder jig, a dipping tank in which a dip coating liquid is stored, and an elevation mechanism which elevates or lowers the dip coating holder jig with respect to the dipping tank.

According to the embodiment, as the porous material absorbs an excessive dip coating liquid, liquid pool between the holder jig and the substrate, droplets dropped from the holder jig, and the generation of a meniscus in the through hole formed in the substrate may be suppressed. As a result, shaking of a liquid surface may be reduced, and the film thickness distribution may be improved.

The holding member used in an embodiment is a member which may hold the substrate by being inserted into the first through hole formed in the substrate. For example, the holding member may be formed of a rod-shaped member, a disk member, a combination of the rod-shaped member and the disk member, or the like.

The rod-shaped member which may be used as the holding member may have a diameter smaller than or equal to a diameter of the first through hole. By inserting the rod-shaped member through the first through holes, the rod-shaped member may support the substrates.

A projecting region may have an outer diameter smaller than or equal to a diameter of the first through hole, and a second through hole smaller than the first through hole may be formed at least at a portion of the disk member which may be used as the holding member. The holding member may hold the substrate by inserting a portion of the projecting region smaller than or equal to the diameter of the first through hole through the first through hole. Further, the rod-shaped member may be inserted into the second through hole.

When the disk member is used as the holding member, the first through hole formed in the substrate is substantially closed by the projecting region of the disk member, and hence, it is possible to prevent the generation of a meniscus in the first through hole formed in the substrate.

The projecting region may be formed on either one surface or both surfaces of the disk member. By preparing a plurality of disk members, each one of respective substrates is disposed between the disk members respectively. Further, by inserting each projecting region into the first through hole formed in the substrate disposed adjacent to the disk member, the respective substrate may be held and also may be disposed at equal intervals. Further, the rod-shaped member may be inserted into the second through hole of each disk member.

The rod-shaped member which may be inserted into the second through hole may have a porous member at least at a portion thereof.

An outer diameter of the disk member may be larger than an outer diameter of the substrate. When the outer diameter of the disk member is larger than the outer diameter of the substrate, the whole substrate is interposed between the disk members. Accordingly, it is possible to reduce the influence of an air flow generated by the volatilization of a solvent, and the film thickness distribution may become more uniform. Further, when the substrates are pulled up from the dip coating liquid, the disk members are pulled up from the dip coating liquid after the substrates are separated from the dip coating liquid. Accordingly, the substrates are less likely to be influenced by shaking of a liquid surface of a dip coating liquid caused at the time of pulling up the disk members from the dip coating liquid.

An outer diameter of the projecting region may be gradually changed from a size smaller than or equal to a hole diameter of the first through hole to a size of an outer diameter of the disk member. By forming the projecting region as described above, it is possible to form the projecting portion at the center portion with a gentle curved shape starting from an outer periphery of the disk member. Accordingly, it is possible to suppress shaking of a liquid surface when the disk members are pulled up from the liquid surface to the minimum.

As a porous material, it is preferable to use a porous material having a porosity of 0 to 90% and a pore diameter of 0.2 μm to 1 mm. It is more preferable to use a porous material having a porosity of 30% or larger and a pore diameter of 10 μm to 800 μm. When a porous material having such porosity and pore diameter is used, the film thickness distribution may become more uniform.

When a porosity of the porous material exceeds 90%, the porous material may become weaker and particles are more likely to be generated from the porous material. When the pore diameter is less than 0.2 μm, breaking of a meniscus is more likely to occur. On the other hand, when a pore diameter exceeds 1 mm, breaking of a meniscus formed in each pore becomes a cause of vibrations of a surface of a solution.

When a porosity of the porous material is less than 30%, an amount of solvent absorbed by the porous material may be reduced, and the film thickness distribution is more likely to be generated between the substrate and the jig made of a porous material due to liquid pool. Further, when a pore diameter is less than 10 μm, since an amount of solvent pooled in the porous material is large, the film thickness may become non-uniform due to a solvent volatilized from the jig made of a porous material after the substrates are pulled up.

As a porous material, it is possible to user a sponge-like organic-material-based porous material made of polyvinyl alcohol (PVA), urethane, polystyrene, fluorine-based polymer or the like. As a porous material, it is also possible to use an inorganic-compound-based porous material containing Al, Si and the like, for example, an inorganic material such as alumina or zeolite. When the inorganic-compound-based porous material is used, a porous material having a porosity of approximately 30% to 50% may be used. When the inorganic-compound-based porous material is used, from a viewpoint of affinity of the porous material with a solution used in dip coating, a minimum pore diameter may be set to approximately 1 μm. A maximum pore diameter may be set to approximately 800 μm.

When the maximum pore diameter exceeds 800 μm, the porous material may become weak. Accordingly, when the porous material is used as a material for forming a jig which holds a substrate, a large number of particles may be generated due to a friction between the porous material and the substrate. Further, breaking of a meniscus may occur in pores, and hence, shaking of a liquid surface may be generated due to breaking of the meniscus.

When a minimum pore diameter is less than 1 μm, the porous material is less likely to absorb a solution, and the film thickness distribution may become non-uniform between the substrate and the jig due to liquid pool.

On the other hand, when a polymer-material-based porous material is used, a porosity is generally equal to or greater than 80%. In the case of a polymer material, even when the porosity is high, polymers are cross-linked to each other, and hence the particles are less likely to be generated unlike the inorganic-compound-based porous material. The pore diameter may be determined based on whether or not the porous material has an affinity with a solvent. When a porous material has an affinity with a solvent, the pore diameter may range from approximately 0.2 μm to approximately 1 mm. When the pore diameter is outside the above-mentioned range, the breaking of a meniscus is likely to occur in a pore and shaking of a liquid surface may be generated due to such breaking of the meniscus.

When a porous material is used for forming a holder jig, since the porous material may absorb a dip coating liquid in the same manner as a sponge, it is possible to improve liquid pool generated in a jig portion. Although breaking of a meniscus, that is, breaking of a film made of a dip coating liquid may occurs in pores, the film is not directly brought into contact with a liquid surface. As a result, it is possible to improve shaking of a liquid surface generated due to breaking of the meniscus.

It is not necessary that the whole jig is made of a porous material. It is sufficient that at least a portion of a surface of a jig which holds the substrates is made of a porous material. For example, the holding member of the holder jig may be formed such that a hanger arm which holds the substrates is formed using aluminum or stainless steel, and, thereafter, an outer periphery of the hanger arm may be covered by a porous material.

The holder jig may improve shaking of a liquid surface generated by breaking of a meniscus, by substantially closing the through hole formed in the substrate. To form a more uniform film on the substrate, it is necessary to make a speed for drying a solvent uniform. A solution absorbed by the porous material is dried in the course of pulling up the substrate. For example, when a jig which closes only a through hole of the substrate such as a disk member is used, a solvent drying speed may be different between a portion in the vicinity of the jig and other portions, and as a result the film thickness distribution may be generated in a formed film. In such a case, it is possible to overcome this drawback by making an outer diameter of the disk member larger than an outer diameter of the substrate. The outer diameter of the disk member may be set to a size equal to or larger than a height of a meniscus formed between the substrate and the liquid surface. In general, a height of the meniscus is approximately several millimeters and hence, an outer diameter of the disk member which configures the holder jig may be set larger than the outer diameter of the substrate by approximately 10 mm. When the outer diameter of the disk member is 20 mm or larger than the outer diameter of the substrate, the size of the holder jig becomes excessively large. Accordingly, even when there is no change in size of the substrate, a size of a dipping tank and an amount of dip coating liquid therein may need to be increased in conformity with the size of the holder jig.

The holder jig may be repeatedly used by cleaning the holder jig. A method of cleaning the holder jig may be suitably changed corresponding to a material to be applied by coating. For example, when a polymer material such as a resist is applied by coating using a jig made of an inorganic-compound-based porous material, the polymer material adhered to the porous material may be cleaned off using a solvent in which a polymer material is soluble. Alternatively, the polymer material adhered to the porous material may be cleaned off by heating the polymer material to a temperature equal to or above a decomposition temperature of the polymer material. On the other hand, when an organic material such as PVA is used for the jig, the organic material may be cleaned off using a drug solution, which may dissolve a solute. However, it is necessary to pay attention so as to prevent the dissolving of a porous material, which is a base material.

When an inorganic material, where a solute to be applied by coating is formed of fine particles, is used, it is possible to use a method of cleaning off an inorganic material using a drug solution which may dissolve the inorganic material, for example, Piranha solution or the like.

Hereinafter, embodiments are described with reference to drawings.

### First Embodiment

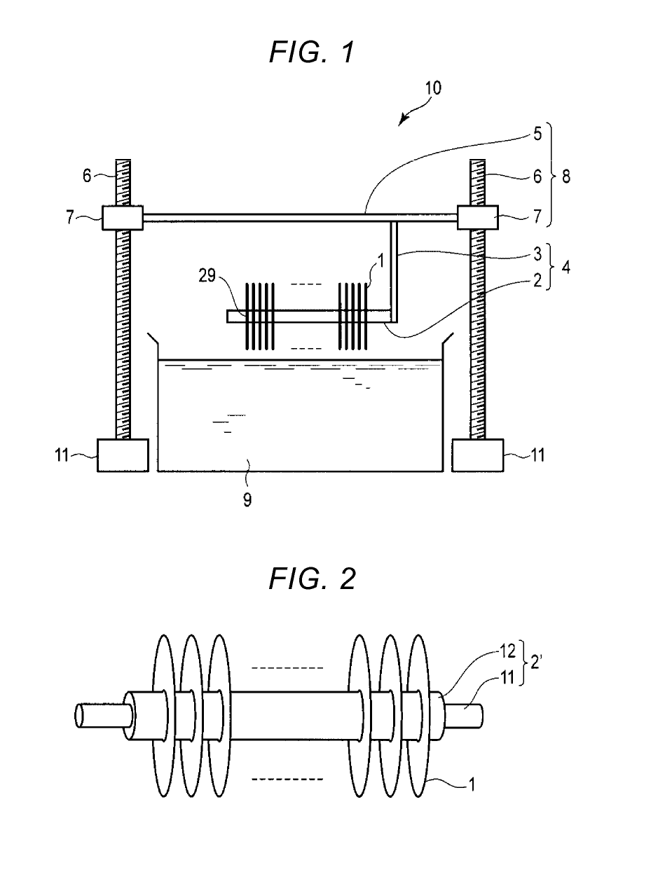

FIG. 1 illustrates a dip coating system according to an embodiment.

As shown in the drawing, the dip coating system 10 according to the first embodiment includes a dipping tank 9, a dip coating holder jig 4, and an elevation mechanism 8. The dipping tank 9 stores a liquid lubricant as a dip coating liquid, and the dip coating holder jig 4 holds substrates. The elevation mechanism 8 can elevate and lower the dip coating holder jig 4 with respect to the dipping tank 9.

The elevation mechanism 8 includes a pair of threaded elevation poles 6, a support member 7, and a horizontal pole 5. The elevation poles 6 are mounted on bases 11 disposed in the vicinity of side surfaces of the dipping tank 9 respectively in a state where the elevation poles 6 extend in the height direction. The support members 7 are mounted on the pair of elevation poles 6 respectively in a relatively elevatable manner. The horizontal pole 5 has both ends thereof fixed to the support members 7 respectively and is disposed horizontally with respect to a liquid surface of the liquid lubricant.

The threaded elevation poles 6 are rotatably mounted on the bases 11 respectively, and may be rotated by a rotation drive unit (not illustrated). The support members 7 and the horizontal pole 5 may be elevated or lowered depending on the direction of rotation of the elevation poles 6.

The dip coating holder jig 4 includes a rod-shaped member 2 and an auxiliary pole 3. The a rod-shaped member 2 passes through first through hole 29 formed at center portions of each of a plurality of substrates 1. The auxiliary pole 3 connects the rod-shaped member 2 to the horizontal pole 5.

HDD media having a size of 2.5 inches are used as the substrates 1. The HDD media are supported by the rod-shaped member 2, which is made of a porous material and passes through the first through holes 29 formed in the base at the center portions of the substrates respectively. The rod-shaped member 2 is connected to the elevation poles 6 by the auxiliary pole 3 and the horizontal pole 5. The rod-shaped member 2 is formed of a porous material which is made of alumina and has a porosity of 30% and a pore diameter of 200 μm.

An outer diameter of the rod-shaped member 2, which is made of the porous material, has a minus tolerance of 0.05 mm with respect to an inner diameter (20 mm) of the HDD media. As there is few clearance between the rod-shaped member 2 and the inner surface of the HDD media, when the HDD media 1 each having a size of 2.5 inches are suspended from the dip coating system 10 having the above-mentioned configuration, the HDD media 1 are supported in a stable manner with the in-plane direction thereof directed in the direction perpendicular to a ground surface. While the HDD media 1 are supported by the rod-shaped member 2, the HDD media 1 are immersed in a liquid lubricant filled in the dipping tank 9. Then, the HDD media 1 are pulled up from the dipping tank 9 together with the holding jig 4 at a speed of 1.5 mm/sec such that a film thickness of a lubricating layer formed of the lubricant becomes 2 nm. In the course of pulling up the HDD media 1 from the dipping tank 9, breaking of a meniscus which is generated when a liquid surface is about to reach the first through hole formed at the center portion of the substrate 1 can be suppressed. As a result, shaking of a liquid surface can be reduced. Further, since the liquid surface is not shaken, the film thickness uniformity of a film formed of a lubricant on the substrate may be improved and a standard deviation of 0.5 nm may be achieved as the film thickness distribution in plane.

When the liquid surface is shaken at the time of pulling up the rod-shaped member, one thin stripe portion which extends horizontally with respect to the liquid surface is formed on each substrate at a portion below the first through hole, and the film thickness is greater at such a portion. It is found that a film thickness at such a portion is 3.2 nm which is approximately 1.5 times larger than film thicknesses of the other portions. A thickness of a film formed using a lubricant may be adjusted by changing a concentration of a lubricant in a lubricant solution besides the adjustment of a pulling-up speed.

FIG. 2 is a schematic view showing another example of the holding member used in the embodiment.

As shown in FIG. 2, in place of the rod-shaped member 2 shown in FIG. 1, a rod-shaped member 2′ may be used. The rod-shaped member 2′ includes the above-mentioned alumina porous material 12 around a pole 11 made of aluminum.

Also in when the rod-shaped member 2′ shown in FIG. 2 is used, it is possible to prevent breaking of a meniscus that is likely to be generated when a liquid surface is about to reach first through holes formed at center portions of substrates. As a result, it is possible to achieve a standard deviation of 0.5 nm in the film thickness distribution in plane. Due to the shaking of the liquid surface generated at the time of pulling up the rod-shaped member, one thin stripe portion which extends horizontally with respect to the liquid surface is formed on each substrate at a portion below the first through hole, and the film thickness is greater at such a portion. It is found that the film thickness at such a portion is 3.2 nm, which is approximately 1.5 times larger than a film thickness of the other portions.

### First Comparison Example

A dip coating system according to a first comparison example is substantially same as the configuration of the dip coating system according to the first embodiment except for that a rod-shaped member made of aluminum is not a porous material unlike the rod-shaped member 2 made of an alumina porous material used in the first embodiment. A diameter of the aluminum-made rod-shaped member used in this embodiment is 5 mm, and substrates are held on the rod-shaped member 2 in a vertical posture with respect to a liquid surface by forming notched portions on an upper portion of the rod-shaped member.

When HDD media 1 are pulled up from a dipping tank 9 together with a holder jig 4 in the same manner as the first embodiment, breaking of a meniscus is formed between an aluminum jig and a coating liquid, and a liquid surface is shaken. Accordingly, the film thickness non-uniformity is caused in a film formed of a lubricant on the substrate. When the film thickness distribution in plane is measured, a standard deviation of the film thickness distribution is 1.5 nm. Further, the film thickness non-uniformity is caused at two thin stripe portions, which extend horizontally with respect to the liquid surface of solution on each substrate. The film thickness non-uniformity at the stripe portion which reaches the first through hole formed at a center portion of the substrate is the film thickness non-uniformity caused by shaking of the liquid surface generated by the breaking of a meniscus occurred in the first through hole at the time of pulling up the jig. The film thickness non-uniformity at the stripe portion which extends below the first through hole is the film thickness non-uniformity caused by the shaking of the liquid surface generated at the time of pulling up the rod-shaped member. It is found that a film thickness at the stripe portion generated due to shaking of the liquid surface generated by breaking of a meniscus is 4.5 nm, which is approximately 2 times larger than a film thickness at the other regions. It is also found that a film thickness at the stripe portion generated below the above-mentioned stripe portion due to shaking of the liquid surface generated at the time of pulling up the rod-shaped member is 3.1 nm.

### Second Embodiment

In a second embodiment, a porous material made of PVA (polyvinyl alcohol) is used instead of the alumina porous material used in the first embodiment. The porous material of PVA, used in this embodiment, has a pore diameter of 150 μm and a porosity of 91%. PVA is soluble to an organic solvent such as alcohol or acetone, but is insoluble to a fluorine-based solvent used as a solvent of a lubricant. A porosity of the porous material of PVA is equal to or greater than 90% so that PVA is softened when PVA is immersed into the solvent. To strengthen a holder jig, an aluminum jig having a diameter of 10 mm is inserted into a center portion of a rod-shaped member made of PVA as described below.

The rod-shaped member made of PVA is softened by immersing the rod-shaped member made of PVA in a solvent in advance. By softening the rod-shaped member made of PVA in advance, portions of the rod-shaped member where substrates are held respectively are slightly indented by the weight of the substrates so that the substrates are stably supported in a vertical posture. In a state where the HDD media are supported by the rod-shaped member, the HDD media are immersed in a liquid lubricant filled in the dipping tank. Then, the HDD media are pulled up from the dipping tank together with the holding jig at a speed of 1.5 mm/sec such that a film thickness of a lubricating layer formed of the lubricant becomes 2 nm.

In the course of pulling up the HDD media from the dipping tank, breaking of a meniscus which is generated when a liquid surface is about to reach the first through hole formed at the center portion of the substrate is suppressed, and, hence, shaking of a liquid surface may be reduced. Accordingly, the film thickness non-uniformity of a film formed of a lubricant on the substrate caused by shaking of the liquid surface of the lubricant may become smaller. As a result, a standard deviation of 0.5 nm may be achieved as the film thickness distribution in plane.

Due to shaking of the liquid surface generated at the time of pulling up the rod-shaped member, one thin stripe portion which extends horizontally with respect to the liquid surface is formed on each substrate at a portion below the first through hole, and the film thickness is greater at such a portion. It is found that a film thickness at such a portion is 3.1 nm, which is approximately 1.5 times larger than film thicknesses of the other portions.

### Third Embodiment

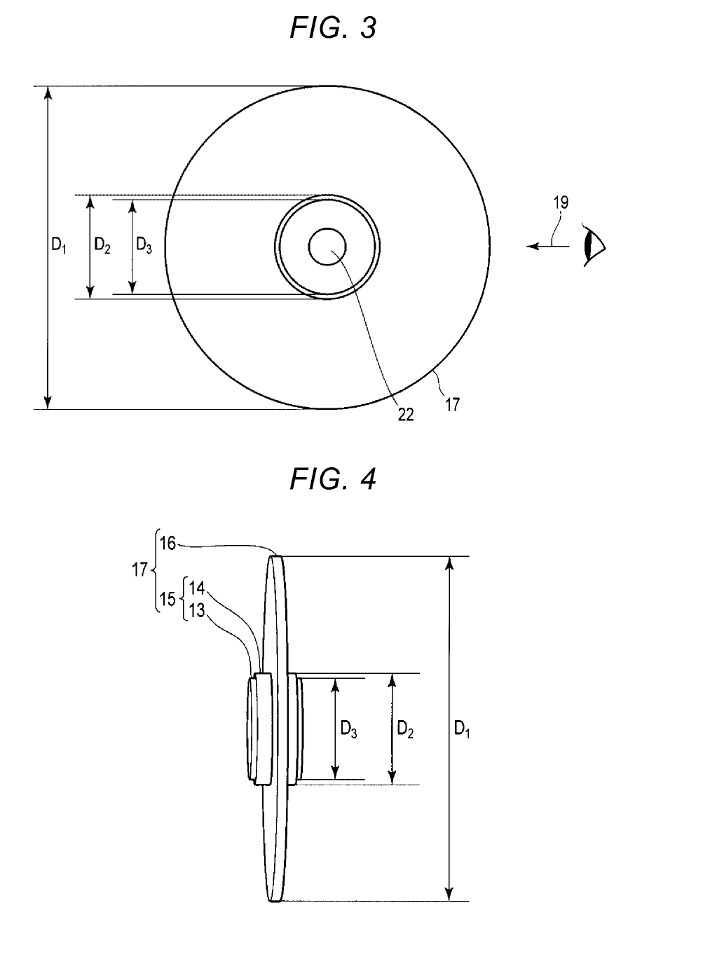

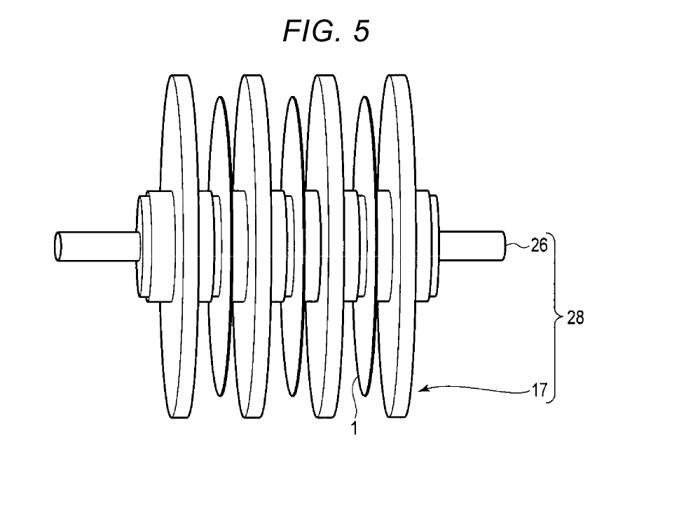

FIG. 3 is a front view of a holding member which may be used in this embodiment, and FIG. 4 is a side view of the holding member shown in FIG. 3 as viewed in the direction indicated by an arrow 19 in FIG. 3.

According to this embodiment, thickness uniformity of the film formed by the dip coating may be further improved by taking into account a volatilizing process of a solvent. As shown in FIGS. 3 and 4, a holding member 17 used in this embodiment is a disk member made of a porous material where a projecting portion 15 is formed at a center portion of a disk 16 having a diameter D1. The projecting portion 15 includes a first projecting portion 13 having a diameter D3 smaller than or equal to a hole diameter of a first through hole formed in a substrate and a second projecting portion 14 having a diameter D2 larger than the hole diameter of the first through hole. A second through hole 22 which allows a horizontal pole to pass therethrough is formed at the center of the projecting region 15.

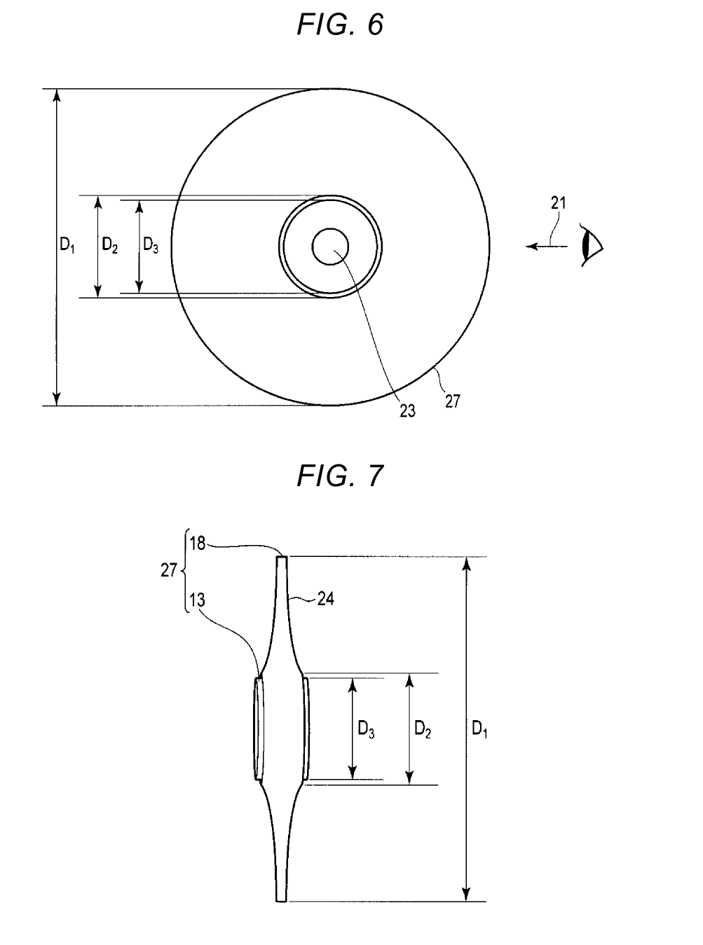

FIG. 5 is a schematic view of a holder jig including a plurality of the disk members.

A holding member 28 has the configuration substantially same as the holding member 2 shown in FIG. 1 except for the following: (i) a plurality of substrates 1 is disposed between a plurality of disk members 17 respectively instead of simply inserting a rod-shaped member 2 made of a porous material through first through holes formed in the plurality of substrates 1; and (ii) a rod-shaped member 26 made of aluminum is inserted through second through holes 22 having the hole diameter smaller than the first through holes. In this embodiment, the first projecting portion 13 is inserted into the first through hole thus holding the substrate 1. On the other hand, as the second projecting portion 14 is not inserted into the first through hole, a certain interval is formed between the substrate 1 and the disk member 17 by an amount equal to a height of the second through hole.

Then, dip coating is carried out on HDD media in the same manner as the first embodiment using the holding member 28. In this embodiment, numeral 1 indicates an HDD medium, and numeral 17 indicates a disk member made of a porous material. The substrates and the disk members made of a porous material are connected with each other by a rod-shaped member 26, which is made of aluminum. The disk member 17 made of a porous material is formed such that the disk member 17 has an outer diameter larger than an outer diameter of the HDD medium 1 by 10% or more. As shown in FIG. 5, with the use of such a holding member 28, the respective HDD media 1 and the disk members 17 are held at certain intervals based on a height of the second projecting portion 14. As a result, a flow of a solvent volatilizing from the porous material may become uniform on surfaces of the substrates so that a speed at which a solvent is dried may become uniform. Accordingly, it is possible to further improve the film thickness uniformity of a film formed of a lubricant on the substrate.

In the same manner as the first embodiment, a lubricating layer is formed by pulling up the HDD media at 1.5 nm/sec so as to form a lubricating layer of 2 nm. The film thickness non-uniformity is generated on a stripe portion on the substrate parallel to a liquid surface of a lubricant due to shaking of the liquid surface caused at the time of pulling up the second projecting portions of the disk members made of a porous material. However, the film thickness non-uniformity is only slightly generated at the other regions on the substrate. Accordingly, it is possible to achieve a standard deviation of 0.4 nm as the film thickness distribution. A film thickness of the stripe portion is approximately 2.4 nm. In view of the above, this embodiment may achieve more favorable in-plane uniformity compared with a medium manufactured using the jig according to the first embodiment. According to the present embodiment, since the disk member made of a porous material is inserted between the respective substrates and hence, shaking of the liquid surface may be absorbed.

### Fourth Embodiment

FIG. 6 is a front view of a holding member used in this embodiment, and FIG. 7 is a side view of the holding member shown in FIG. 6 as viewed in the direction indicated by an arrow 21 in FIG. 6.

As shown in FIGS. 6 and 7, a disk member 27 of this embodiment is substantially same as the disk member 17 of the third embodiment except for that the disk member 27 has an integrated body of a second projecting portion and a disk 18. Specifically, an outer diameter of the second projecting portion is gradually changed from the outer diameter of the second projecting portion to an outer diameter of the disk 18 so that the second projecting portion is integrally formed with the disk 18. That is, a surface 24 of the disk member 27 is formed by a gentle curve.

Then, dip coating is carried out on HDD media in the same manner as the third embodiment except for that the disk members 27 are used instead of the disk members 17. By using the disk members 27, it is possible to minimize shaking of a liquid surface generated at the time of pulling up a jig from a liquid lubricant. Accordingly, the film thickness non-uniformity of a film formed of a lubricant on the substrate may be minimized. In the same manner as the first embodiment, a lubricating layer is formed by pulling up the HDD media at a speed of 1.5 nm/sec so as to form a lubricating layer of 2 nm.

As a result, the stripe portion generated in the first to third embodiments is not generated in this embodiment, and a standard deviation of 0.2 nm may be achieved as the film thickness distribution. According to the present embodiment, since the structure of a lower side of the jig is formed gently with respect to a liquid surface, shaking of the liquid surface may be suppressed to the minimum. By inserting a disk-shaped porous material between the respective substrates, shaking of the liquid surface may be absorbed.

The liquid lubricant is used as a dip coating liquid in the embodiment. However, an organic resist for lithography, an organic material for surface treatment, a solvent in which fine particles are dispersed, or the like may be also used as the dip coating liquid.

### Fifth Embodiment

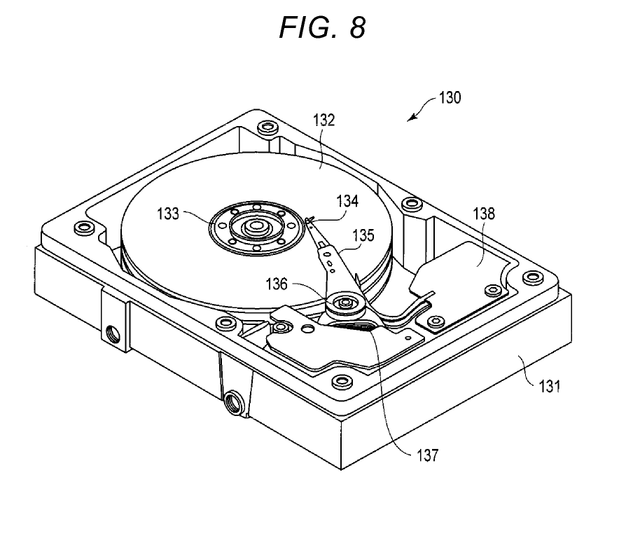

FIG. 8 is a perspective exploded view of a magnetic recording and reproducing apparatus having a magnetic recording medium manufactured through the coating using the dip coating system according to one of the above embodiments.

As shown in FIG. 8, a magnetic recording and reproducing apparatus 130 includes a rectangular box-shaped casing 131 and a top cover (not illustrated). The rectangular box-shaped casing 131 has an opened upper surface, and the top cover is fixed to the casing 131 using a plurality of screws so as to close an upper end opening of the casing.

The casing 131 houses therein a magnetic recording medium 132 according to the embodiment, a spindle motor 133 which configures a driving means which supports and rotates the magnetic recording medium 132, a magnetic head 134 which performs recording and reproducing of magnetic signals with respect to the magnetic recording medium 132, a head actuator 135 which has a suspension mounting the magnetic head 134 on a distal end thereof, and supports the magnetic head 134 in a movable manner with respect to the magnetic recording medium 132, a rotary shaft 136 which rotatably supports the head actuator 135, a voice coil motor 137 which rotates the head actuator 135 and performs the positioning of the head actuator 135 by the rotary shaft 136, a head amplifier circuit substrate 138, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A tool for dip-coating a disc-shaped substrate having a through hole therein, comprising:
a support member having a portion made of a porous material, that is to be inserted into the through hole and support the disc-shaped substrate during dip-coating.

2. The tool according to claim 1, wherein
the support member includes a core member, and the portion made of the porous material is formed around the core member.

3. The tool according to claim 1, wherein
the support member is a shaft having a circular cross sectional shape and a diameter smaller than a diameter of the through hole.

4. The tool according to claim 1, wherein
the portion made of the porous material has a porosity equal to or greater than 30% and equal to or smaller than 90%.

5. The tool according to claim 1, wherein
a pore diameter of the portion is equal to or greater than 0.2 μm and equal to or smaller than 1 mm.

6. The tool according to claim 5, wherein
the pore diameter of the portion is equal to or greater than 10 μm and equal to or smaller than 800 μm.

7. The tool according to claim 1, further comprising:
a holding member holding the support member in an horizontal direction; and
an elevation unit configured to move up the holding member.

8. A tool for dip-coating an annular-disc-shaped substrate, comprising:
a first disc member having a portion that is to be inserted into the substrate and a first through hole;
a second disc member having a portion that is to be in contact with the portion of the first disc member and a second through hole; and
a support member to be inserted into the first and second through holes while the substrate is placed between the first disc member and the second disc member and the portion is inserted into the substrate, wherein
at least one of the first disc member, the second disc member, and the support member has a portion made of a porous material.

9. The tool according to claim 8, wherein
the first disc member has a second portion that defines an outer periphery of the first disc member and on which the portion to be inserted into the substrate is formed, and
an outer diameter of the first disc member gradually decreases from the second portion towards the portion to be inserted into the substrate.

10. The tool according to claim 8, further comprising:
a holding member holding the support member in an horizontal direction; and
an elevation unit configured to move up the holding member.

11. The tool according to claim 8, wherein
outer diameters of the first and second disc members are greater than an outer diameter of the substrate.

12. A method for dip-coating a disc-shaped substrate having a through hole therein, comprising:
supporting the substrate on a portion of a tool, the portion being made of a porous material;
submerging the substrate and the tool into a dip coating liquid; and
taking the substrate and the tool out of the dip coating liquid.

13. The method according to claim 12, wherein
the tool includes a bar-shaped member having a surface formed of a porous material, and
the bar-shaped member is inserted into the through hole of the substrate to support the substrate.

14. The method according to claim 13, wherein
the bar-shaped member has a circular cross sectional shape having a diameter smaller than a diameter of the through hole.

15. The method according to claim 12, wherein
the portion made of the porous material has a porosity equal to or greater than 30% and equal to or smaller than 90%.

16. The method according to claim 12, wherein
a pore diameter of the portion is equal to or greater than 0.2 μm and equal to or smaller than 1 mm.

17. The method according to claim 16, wherein
the pore diameter of the portion is equal to or greater than 10 μm and equal to or smaller than 800 μm.

18. The method according to claim 12, wherein
the tool includes a first disc member having a through hole, and a second disc member having a through hole, and a bar-shaped member that is inserted into the through holes of the first and second disc members, and
the substrate is placed between the first disc member and the second disc member.

19. The method according to claim 18, wherein
the first disc member has a first portion inserted into the through hole of the substrate to support the substrate and a second portion that defines an outer periphery of the first disc member and on which the first portion is formed, and
an outer diameter of the first disc member gradually decreases from the second portion towards the first portion.

20. The method according to claim 18, wherein
outer diameters of the first and second disc members are greater than an outer diameter of the substrate.
